(19) United States
(12) Patent Application Publication
(10) Pub. No.: US 2010/0095030 A1
(43) Pub. Date: Apr. 15, 2010

(54) CONTROL MANAGEMENT SYSTEM

(75) Inventor: I - Wei CHIU, Taipei (TW)

Correspondence Address: Patterson & Sherldan - ATEN, 3040 Post Oak Boulevard, Suite 1500, Houston, TX, 77056, US

(73) Assignee: ATEN INTERNATIONAL CO., LTD., Taipei (TW)

(21) Appl. No.: 12/252,009

(22) Filed: Oct. 15, 2008

(51) Int. Cl. G06F 13/10

(52) U.S. Cl. 710/67

(57) ABSTRACT

A control management system includes a plurality of electrical devices, each electrical device generating an audio, a keyboard-video-mouse (KVM) switch, and a display. The KVM switch includes a plurality of audio detecting units, each audio detecting unit receiving an audio, and accordingly generating a detecting signal, and a processor receiving the detecting signals and accordingly generating at lease one status signal. The display is used for displaying operating statuses of the audios according to the status signal.

### BACKGROUND OF THE INVENTION

1. Field of the Invention

The present invention relates to a control management system for monitoring and managing remote electrical devices in noisy environments, and more particularly, to a control management system capable of monitoring and managing remote electrical devices by detecting audio variations of the electrical devices, and reading the detecting result with on screen display menu and/or light-twinkling.

2. Description of the Related Art

A keyboard-video-mouse (KVM) switch has been developed as an important solution of multi-users, remote access and management for a network interconnecting a large number of console devices and a large number of computers thereto. A KVM extender enables a computer interface to be located at a greater distance from the computer than is typically possible with a standard interface. For example, a company can place all its employees' computers in a rack-mounted system in a locked room and yet still provide a standard KVM interface at each employee's desk. To the employee, it appears as though the computer is still located at the employee's desk. This centralization of computers enables companies to maintain tighter security over their computers and also simplifies the computers' maintenance by locating them in a single place.

The KVM switch may be accessible over a LAN via a common protocol, such as a transfer control protocol/Internet protocol (TCP/IP). Generally, a user or system administrator can access the remote computers attached to the KVM switch utilizing an Internet browser or client software associated with the KVM switch. Once the remote computer has been selected, the remote computer's video signal is routed to workstation's video monitor of the user and a user may then utilize a keyboard and/or mouse to control the remote computer. The KVM switch may additionally include a connection to the power source of the remote computer for a hard reboot in case of a system failure. With a KVM switch, the user can access multiple computers with a single interface, thus reducing the cost of components and maintenance.

Traditionally, the keyboard, video, mouse data are transmitted and received between the KVM switch and the computers by respective cables. Also, these cables connect the computers and the keyboard-video-mouse switch through respective terminals, i.e. the video connectors (commonly, D-sub 15 pins VGA connectors), the mouse connectors and the keyboard connectors (commonly, PS/2 or Universal serial bus (USB) connectors). Once the number of the computers connected to the keyboard-video-mouse switch is more and more increased, these sets of keyboard-video-mouse cables correspondingly occupy a lot of space between the keyboard-video-mouse switch and the connected computers. Especially, the occupying space of many cables grows up for a racked, clustered computers or servers due to the less space for the setup of these computers. Meanwhile, the large number of cables required by the number of the connected computers dose not only occupy lots of spaces but also cause the bad radiation of the KVM switch, the computers and the cables themselves.

Please refer to FIG. 1, which illustrates a system of using a keyboard-video-mouse switch and a keyboard-video-mouse extender to transmit the keyboard/mouse data and receiving the video/audio data stream to/from the computer 300 and 302 with respective cables. The keyboard-video-mouse switch 130 is connected with a first workstation which contains a keyboard 132, a mouse 134 and a display 136. The display 136 is coupled to the keyboard-video-mouse switch 130 for receiving the video signals to show operation information for users. For example in a big rack, clustered computers are setup to be connected to a keyboard-video-mouse switch 130 for being remote accessed. If twenty computers are setup, there will be sixty cables crowed in the whole rack. Additionally, the KVM switch 130 also accommodates a second workstation that may be relatively far from the KVM switch 130, for example 400 feet away. The second workstation includes a keyboard 142, a mouse 144, and a display 146. In order to accommodate the relative distance between the second workstation and the KVM switch 130, a KVM extender 140 between the second workstation and the KVM switch 130 is required. The KVM extender 140 is coupled to the KVM switch 130 via a CAT5 cable, or an optic fiber cable.

Nevertheless, in a noisy environment, an on-site system administrator manipulates the first workstation connected to the keyboard-video-mouse switch 130 may ignore low tone which possibly indicates an alarm for above-normal temperature or malfunction of any computers 300, 302, resulting in a risk of failure of computers 300, 302. The user may hear the audio from the only one computer controlled via the KVM switch, but fails to hear the audios from other computers uncontrolled via the KVM switch.

### SUMMARY OF THE INVENTION

Consequentially, there is a need to develop a system having a keyboard-video-mouse switch capable of monitoring all audios from the computer. Such a system should allow a user to view all available remote computers via an on-screen user interface and to choose one of these computers to monitor and control. The system should aid in managing remote noisy environments.

It is therefore a primary objective of this invention to provide a control management system for detecting and displaying all audios from the electrical devices to solve the existing problem.

Accordingly, the present invention provides a control management system comprises a plurality of electrical devices, each electrical device generating an audio, a control management module, and a display. The control management module comprises a plurality of audio detecting units, each audio detecting unit receiving an audio, and accordingly generating a detecting signal, and a processor receiving the detecting signals and accordingly generating at lease one status signal. The display is used for displaying operating statuses of the audios according to the status signal.

According to the present invention, a keyboard-video-mouse (KVM) switch comprises a plurality of audio detecting units, and a processor coupled to the audio detecting units, for generating a plurality of status signals based on the detecting signals. Each audio detecting unit corresponds to one of a plurality of electrical devices, and is used for receiving audio signals from the electrical devices, and converting each of the received audio signals into a plurality of detecting signals.

According to the present invention, a method of detecting statuses of a plurality of electrical devices is disclosed. Each electrical device corresponds to an audio unit for generating an audio signal. The method comprises steps of receiving audio signals from the electrical devices, converting each of the received audio signals into a plurality of detecting signals, generating a plurality of detecting signals based on comparisons between the detecting signals and at least one reference values, and using a display to display operating statuses of the electrical devices based on the status signals.

These and other objectives of the present invention will become apparent to those of ordinary skill in the art after reading the following detailed description of the preferred embodiments illustrated in the various figures and drawings.

### BRIEF DESCRIPTION OF THE DRAWINGS

FIG. 1 illustrates a system of using a keyboard-video-mouse switch and a keyboard-video-mouse extender to transmit the keyboard/mouse data and receiving the video/audio data stream to/from the computers with respective cables.

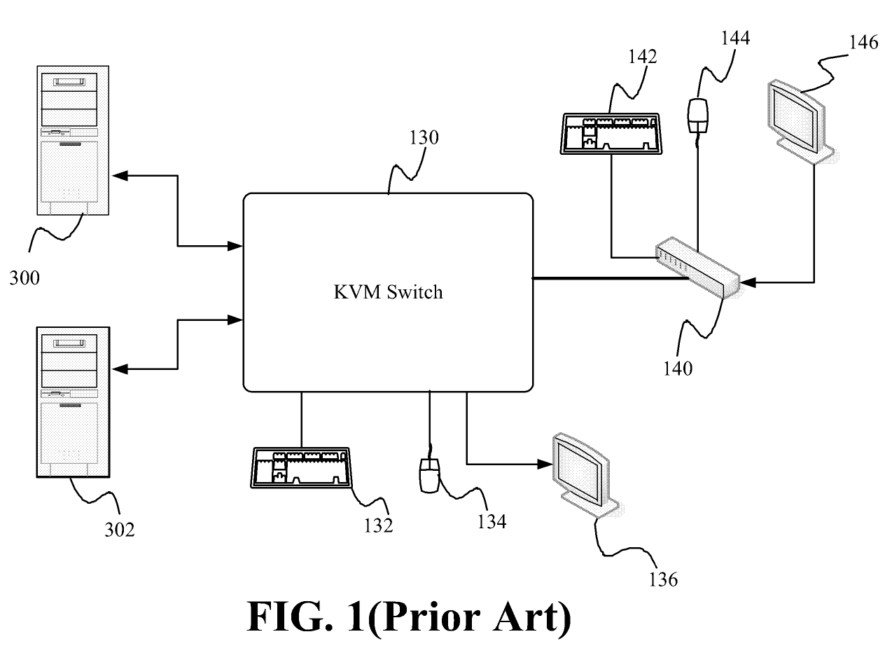

FIG. 2A shows a block diagram of a control management system according to a first embodiment of the present invention.

FIG. 2B shows a block diagram of a control management system according to a second embodiment of the present invention.

FIG. 2C shows a block diagram of a control management system according to a third embodiment of the present invention.

FIG. 3 illustrates a flowchart of method of the according to the preferred embodiment of the present invention.

FIG. 4 shows a circuit diagram of the audio detecting unit as shown in FIGS. 2A-2C.

FIG. 5 shows voltage variation of input/output of the circuits in FIG. 4.

### DETAILED DESCRIPTION OF THE INVENTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

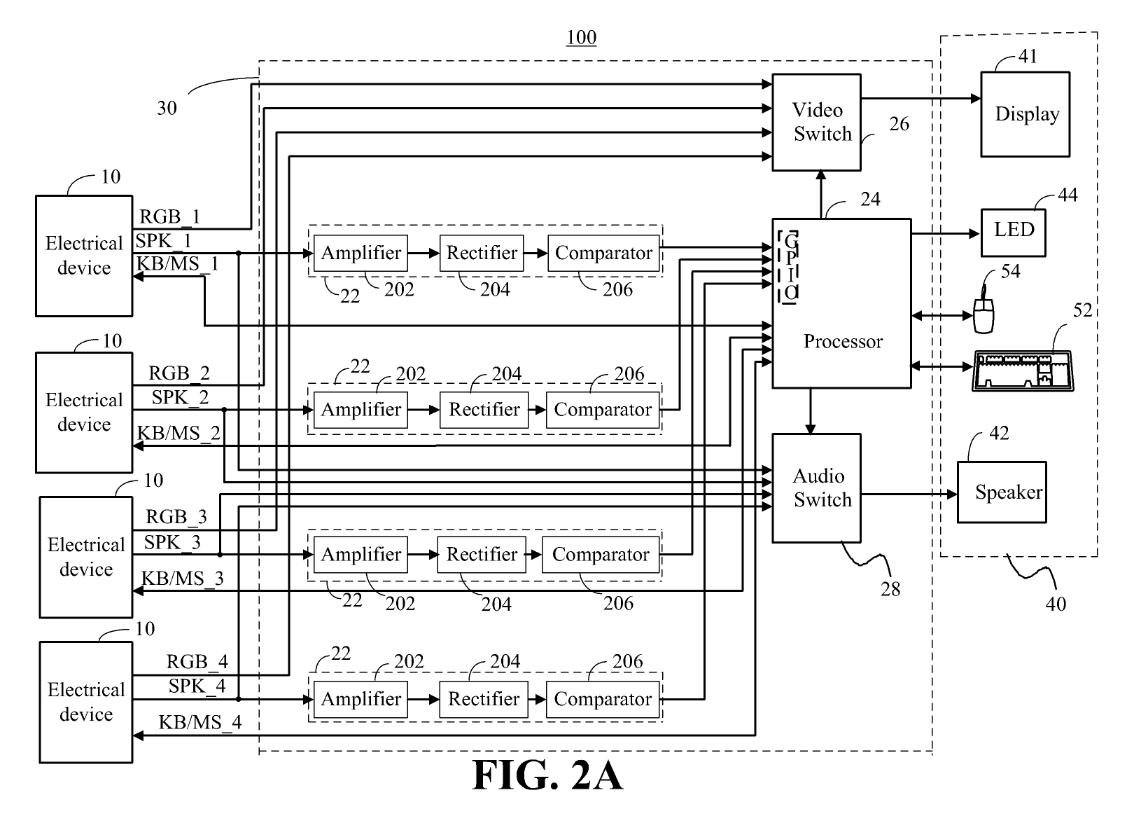

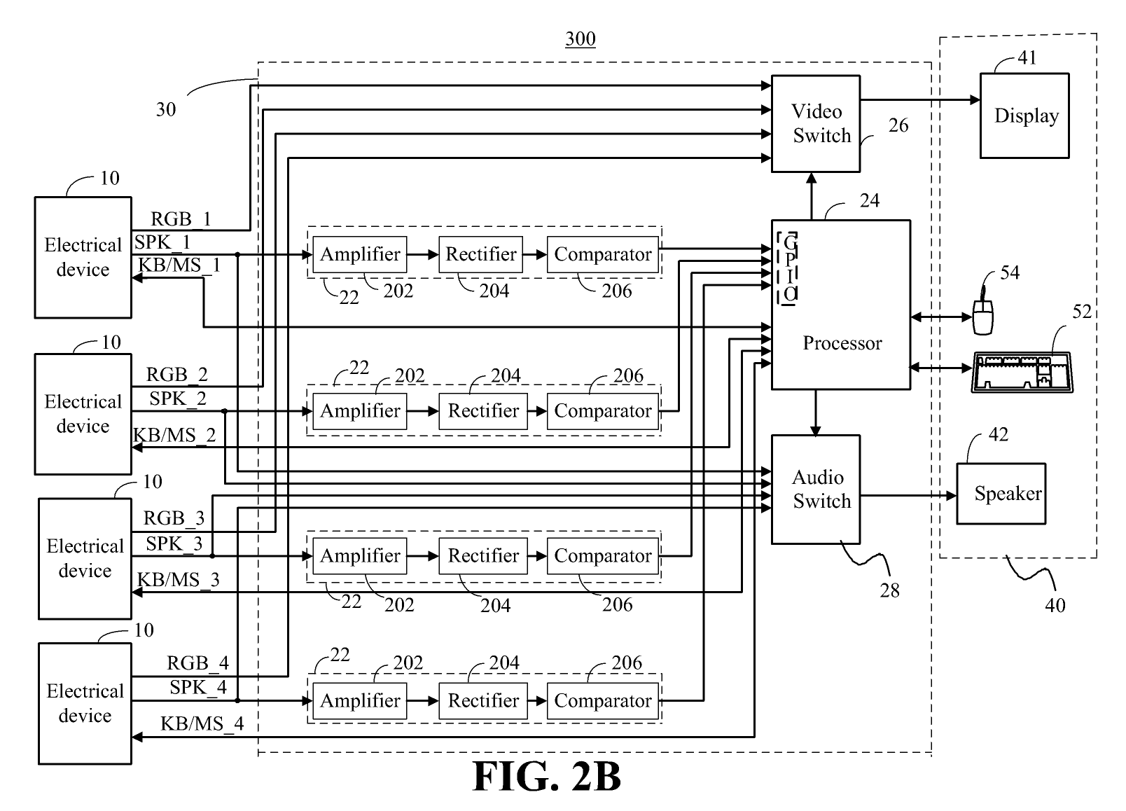

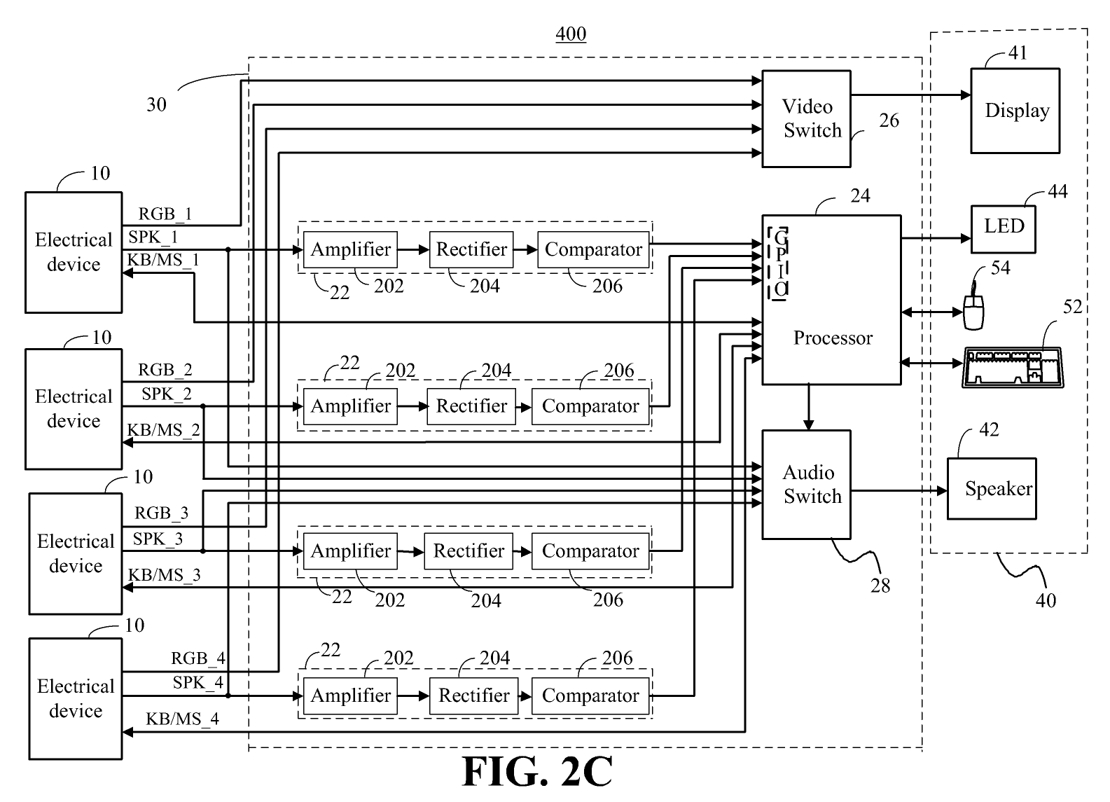

Referring to FIG. 2A showing a block diagram of a control management system 100 according to a first embodiment of the present invention, the control management system 100 comprises a plurality of electrical devices (e.g. personal computers or personal digital assistants) 10, a control management module, and a console 40. The control management module is capable of remotely monitoring and controlling electrical devices 10 by means of the console 40 for user's operation, which may comprise a keyboard 52, a cursor control device (e.g. a mouse 54 or a trackball), an audio device (e.g. a speaker 42 or a microphone), a display 41, lights (e.g. light emitting diodes 44) or other console devices. A control management module, i.e. a keyboard-video-mouse (KVM) switch 30, is coupled with the keyboard 52, the mouse 54, the audio device (i.e. the speaker 42 and/or the microphone), and the display 41, and is capable of transmitting the keyboard/cursor control signal KB/MS_1, KB/MS_2, KB/MS_3, or KB/MS_4 to control the operation of the electrical devices 10. The KVM switch 30 comprises a plurality of audio detecting units 22, a processor 24, a video switch 26, and an audio switch 28. The video switch 26 is coupled to each electrical device 10 for switching to a route to select and deliver a video signal RGB _1, RGB _2, RGB _3, or RGB_4 from one of the electrical devices 10 to the display 41 under the control of the processor 24. Each audio detecting unit 22 corresponds and couples to one of the electrical devices 10. The processor 24 is coupled to each audio detecting unit 22 through a GPIO pin. Each audio detecting unit 22 is coupled between the corresponding electrical device 10 and the processor 24. Each audio detecting unit 22 receives audio signal from the corresponding electrical device 10 and accordingly outputs a detecting signal to the processor 24. Each audio detecting unit 22 comprises an amplifier 202, a rectifier 204, and a comparator 206. The rectifier 204 is coupled between the corresponding amplifier 202 and the corresponding comparator 206. The amplifier 202 is coupled between the corresponding electrical device 10 and the corresponding amplifier 202. The comparator 206 is coupled between the corresponding rectifier 204 and the processor 24. The processor 24 receives the detecting signals and accordingly generates at lease one status signal indicative of the amplitude of audio signal SPK_1, SPK_2, SPK_3, or SPK_4 from the electrical device 10, and sends the at least one status signal to the video switch 26 and/or to the lights(such as the LEDs 44). The video switch 26 overlaps the status signal (such as OSD) and the selected video signal to output an overlapped video signal to the display 41. The LEDs 44 twinkle in response to the status signals received. In one embodiment, the LEDs 44 are disposed externally or internally on the enclosure of the KVM switch 300. The audio switch 28 can switch to a route to deliver the audio signal SPK_1, SPK_2, SPK_3, or SPK_4 from the detected electrical device 10 to the speaker 42 under the control of the processor 42.

It is noted that the control management system 300, as shown in FIG. 2B, shows operating statuses of the electrical devices 10 based on the detecting signals by utilizing the display 41 with the OSD menu, excluding the lights (such as LEDs). In another embodiment, the control management system 400, as shown in FIG. 2C, shows operating statuses of the electrical devices 10 based on the detecting signals by only lights (such as LEDs) without showing the OSD menu on the display 41. Similar to the control management system 100 shown in FIG. 2A, the KVM switch 30 comprises a plurality of audio detecting units 22, a processor 24, a video switch 26, and an audio switch 28. The video switch 26 is coupled to each electrical device 10 for switching to a route to select and deliver a video signal RGB _1, RGB _2, RGB _3, or RGB_4 from one of the electrical devices 10 to the display 41 under the control of the processor 24. Each audio detecting unit 22 corresponds and couples to one of the electrical devices 10. The processor 24 is coupled to each audio detecting unit 22 through a GPIO pin. Each audio detecting unit 22 comprises an amplifier 202, a rectifier 204, and a comparator 206. Each audio detecting unit 22 outputs a detecting signal to the processor 24 by receiving the audio signal or detecting no audio signal. The processor 24 receives the detecting signals and accordingly generates at lease one status signal indicative of the amplitude of audio signal SPK_1, SPK_2, SPK_3, or SPK_4 from the electrical device 10, and sends the at least one status signal to the video switch 26 in FIG. 2B or to the lights (such as LEDs 44) in FIG. 2C. The video switch 26 overlaps the status signal (such as OSD) and the selected video signal to output an overlapped video signal to the display 41. The LEDs 44 twinkle in response to the status signals received. The audio switch 28 can switch to a route to deliver the audio signal SPK_1, SPK_2, SPK_3, or SPK_4 from the detected electrical devices 10 to the speaker 42 under the control of the processor 24. In one embodiment, the processor 24 may be CPLD (Complex Programmable Logic Device), FPGA (Field-Programmable Gate Array) or ASIC (Application-Specific Integrated Circuit). The video switch 26 may include a multiplexer and a video overlapped circuit. The audio switch 28 may be a multiplexer.

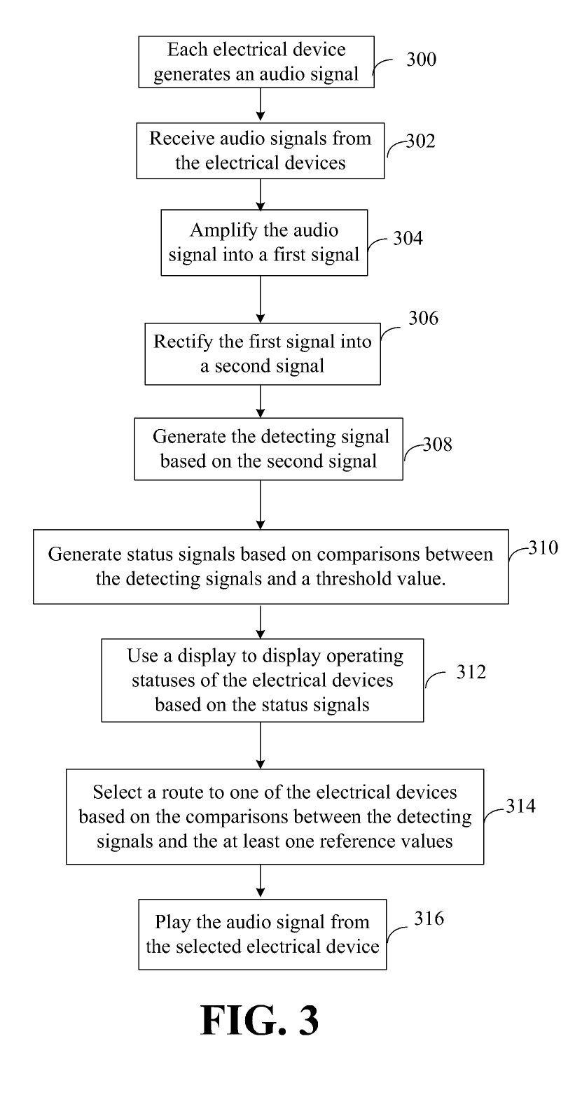

With reference to FIG. 3 illustrating a flowchart of method of the according to the preferred embodiment of the present invention, the method comprises steps of:
Step 300: Each electrical device generates an audio signal and outputs to the KVM switch.
Step 302: Receive audio signals from the electrical devices by the KVM switch.
Step 304: Amplify the audio signal into a first signal by the KVM switch.
Step 306: Rectify the first signal into a second signal by the KVM switch.
Step 308: Generate the detecting signal based on the second signal comparisons between the detecting signals and a threshold value by the KVM switch.
Step 310: Generate at lease one status signals based on comparisons between the detecting signals and a threshold value by the KVM switch.
Step 312: Use a display to display operating statuses of the electrical devices based on the status signals.
Step 314: Select a route to one of the electrical devices based on the comparisons between the detecting signals and the at least one reference values by the KVM switch.
Step 316: Play the audio signal from the selected electrical device.

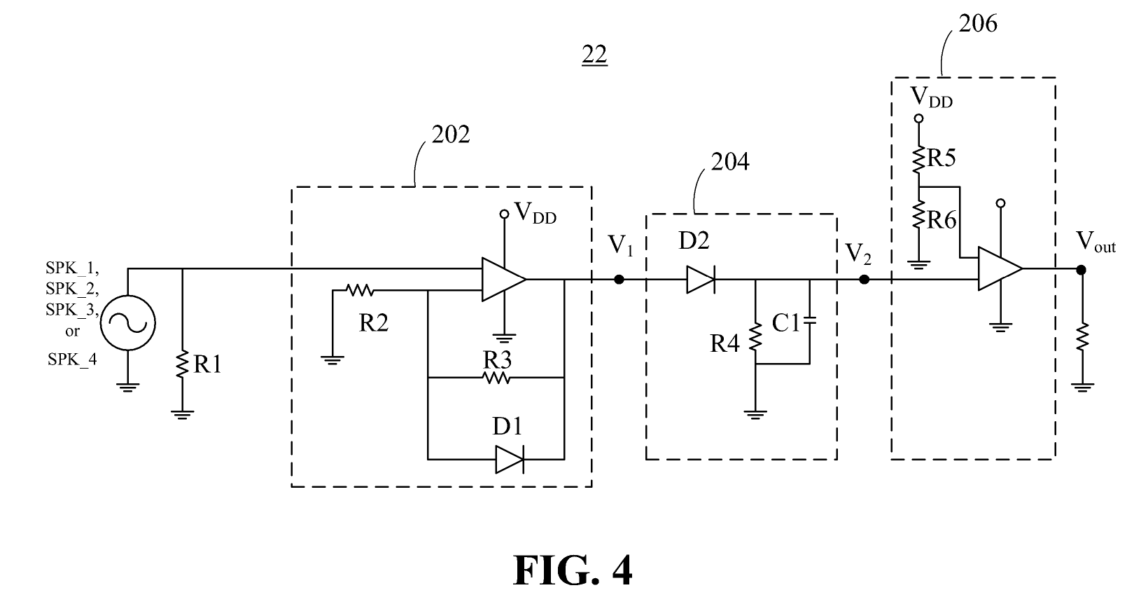

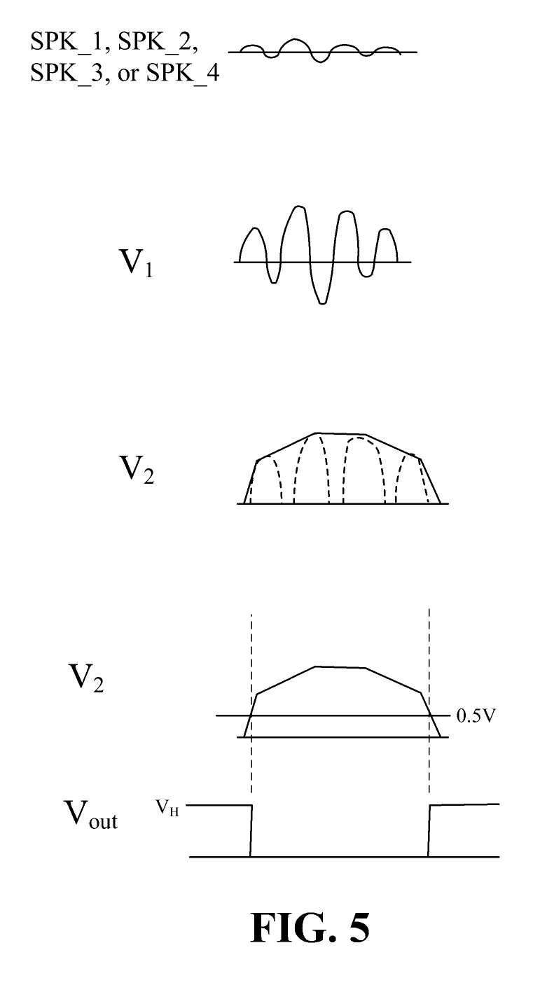

With reference to FIG. 4, FIG. 4 shows a circuit diagram of the audio detecting unit 22 as shown in FIGS. 2A˜2C, and FIG. 5 shows voltage variation of input/output of the circuits in FIG. 4. When the electrical devices 10 is enabled to generate audio signals SPK_1, SPK_2, SPK_3, or SPK_4 (Step 300), each audio detecting unit 22 receives the audio signal SPK_1, SPK_2, SPK_3, or SPK_4 from the corresponding electrical device 10 (Step 302). The amplifier 202 comprises resistors R2, R3, a diode D1 and an operational amplifier, and is used for amplifying the audio signal SPK_1, SPK_2, SPK_3, or SPK_4 from corresponding electrical device 10 into a first signal V₁ (Step 304). The rectifier 204 comprises a diode D2, and a resistor R4 and a capacitor C2 connected in parallel, and is used for rectifying the first signal V₁ into a second signal V₂ (Step 306). The comparator 206 is used for comparing the second signal V₂ with a threshold value (e.g. 0.5V), and thus generating the detecting signal Vout (Step 308). The partition of V₂ larger than the threshold value corresponds to zero of Vout. The partition of V₂ lower than the threshold value corresponds to V_{H} (V_{DD}) of Vout. It is noted that, as a skill person in this art is aware, the amplifier 202, the rectifier 204, and the comparator 206 shown in FIG. 4 is an embodiment, but are not limitations. As long as the amplitude of the rectified second signal V₂ is lower than the threshold value, it indicates the corresponding device 10 is normal, otherwise, the comparator 206 generates a detecting signal indicating amplitude of audio signal from each electrical device 10 in excess of the threshold value. The processor 24 receives the detecting signals and accordingly generates at lease one status signal indicative of the amplitude of the audio signal SPK_1, SPK_2, SPK_3, or SPK_4 from the electrical device 10, and sends the at least one status signal to the video switch 26 and/or the lights (such as LEDs 44) (Step 310). Finally, the status signal is an On Screen Display (OSD) menu overlapped in the video signal from the electrical device 10 shown on the display 41, or shown as light indication by the LEDs 44 (Step 312). The user understands which electrical device has audio signal output via the OSD menu and/or light indication. Then, the user can switch the speaker to connect to one electrical device via hot key in the OSD menu, keyboard, mouse or button in the KVM switch. The video switch 26 overlaps the video signal RGB _1, RGB _2, RGB _3, or RGB_4 and the OSD menu information into an overlapped video, and the display 41 displays the overlapped video for representing operations statuses of the audio signals. If the processor 24 detects the amplitude of the detecting signal over the threshold value, the audio switch 28 can switch to a route to deliver the audio signal SPK_1, SPK_2, SPK_3, or SPK_4 from the detected electrical devices 10 to the speaker 42 (Step 314). The speaker 42 plays the audio signal SPK_1, SPK_2, SPK_3, or SPK_4 from the detected electrical device 10, accordingly (Step 316).

In doing so, even if in a noisy environment, the users can monitor the statuses of all electrical device 10 coupled to the KVM switch 30 by reading the status signal shown on the display 41. In another embodiment, the console 40 comprises a plurality of lights (e.g. light emitting diodes 44), each light corresponding to one of the electrical devices 10. The lights twinkles to display operating statuses of the electrical devices based on the detecting signals (Step 316).

In addition, the processor 24 also receives a cursor/keyboard control signal KB/MS_1, KB/MS_2, KB/MS_3, or KB/MS_4 from the keyboard 52 or the mouse 54 coupled to the control management module (such as KVM switch), and outputs the cursor/keyboard control signal KB/MS_1, KB/MS_2, KB/MS_3, or KB/MS_4 to one of the electrical devices 10 in order to remotely control the selected electrical device 10. The KVM switch may detect of whether each electrical device outputs audio signal by showing OSD menu in the display or indicating in lights (such as LEDs). The user can know which electrical device outputs the audio signal soon and processes the detected audio signal in the best mode without losing any audio signal from the electrical devices when the user is busy.

The present invention has been described with reference to certain preferred and alternative embodiments which are intended to be exemplary only and not limited to the full scope of the present invention as set forth in the appended claims. Accordingly, the scope of the invention shall be determined only by the appended claims and their equivalents.

What is claimed is:

1. A control management system comprising:
a plurality of electrical devices, each electrical device generating an audio;
a control management module comprising:
a plurality of audio detecting units, each audio detecting unit receiving an audio, and accordingly generating a detecting signal; and
a processor receiving the detecting signals and accordingly generating at lease one status signal; and
a display displaying operating statuses of the audios according to the status signal.

2. The system of claim 1, further comprising a video switch for switching to a route to deliver a video from one of the electrical devices to the display.

3. The system of claim 2, wherein the status signal is an on screen display (OSD) menu, the video switch overlaps the video and the OSD menu into an overlapped video, and the display displays the overlapped video for representing operations statuses of the audios.

4. The system of claim 1, wherein each audio detecting unit comprises:
an amplifier amplifying the audio into a first signal;
a rectifier rectifying the first signal into a second signal; and
a comparator generating the detecting signal according to the second signal and a threshold value.

5. The system of claim 1, wherein the processor is coupled to each audio detecting unit through a GPIO pin.

6. The system of claim 1, further comprising a cursor control device/keyboard coupled to the control management unit for generating a cursor/keyboard control signal, wherein the control management unit further outputs the cursor/keyboard control signal to one of the electrical devices.

7. The system of claim 1, further comprising:
an audio switch coupled to the electrical devices for selecting a route to deliver one of the audios; and
a speaker coupled to the audio switch for playing the audio delivered from the audio switch.

8. The system of claim 1, wherein the display comprises a plurality of lights, each light corresponds to an audio, for twinkling in response to the status signals.

9. A keyboard-video-mouse (KVM) switch, comprising:
a plurality of audio detecting units, each audio detecting unit corresponding to one of a plurality of electrical devices, for receiving audio signals from the electrical devices, and converting each of the received audio signals into a plurality of detecting signals; and
a processor coupled to the audio detecting units, for generating a plurality of status signals based on the detecting signals.

10. The KVM switch of claim 9, further comprising a video switch for switching to a route to deliver a video from one of the electrical devices to a display.

11. The KVM switch of claim 10, wherein the status signal is an on screen display (OSD) menu, the video switch overlaps the video and the OSD menu into an overlapped video, and the display displays the overlapped video for representing operations statuses of the audios.

12. The KVM switch of claim 9, wherein each of audio detecting units comprises:
an amplifier for amplifying the audio signal into a first signal;
a rectifier coupled to the amplifier, for rectifying the first signal into a second signal; and
a comparator coupled to the rectifier, for generating the detecting signal based on the second signal.

13. The KVM switch of claim 9, further comprising a cursor control device/keyboard coupled to the control management unit for generating a cursor/keyboard control signal, wherein the control management unit further outputs the cursor/keyboard control signal to one of the electrical devices.

14. The KVM switch of claim 9, further comprising:
an audio switch coupled to the electrical devices for selecting a route to one of the electrical devices based on the comparisons between the detecting signals and the at least one reference values.

15. The KVM switch of claim 9, further comprising a plurality of lights connected to the processor for twinkling in response to the status signals.

16. A method of detecting statuses of a plurality of electrical devices, each electrical device corresponding to an audio unit for generating an audio signal, the method comprising:
receiving audio signals from the electrical devices;
converting each of the received audio signals into a plurality of detecting signals;
generating a plurality of status signals based on comparisons between the detecting signals and a threshold value; and
using a display to display operating statuses of the electrical devices based on the status signals.

17. The method of claim 16, wherein the step of converting each of the received audio signals comprises:
amplifying the audio signal into a first signal;
rectifying the first signal into a second signal; and
generating the detecting signal based on the second signal.

18. The method of claim 16, further comprising:
selecting a route to one of the electrical devices based on the comparisons between the detecting signals and the threshold value.

19. The method of claim 18, further comprising:
playing the audio signal from the selected electrical device.

20. The method of claim 16, wherein the display comprises a plurality of lights, each light corresponding to one of the electrical devices, and the method further comprises a step of the lights twinkling to display operating statuses of the electrical devices based on the status signals.
